(19) United States
(12) Patent Application Publication
(10) Pub. No.: US 2002/0188727 A1
(43) Pub. Date: Dec. 12, 2002

(54) Method for processing external data for access and manipulation through a host operating environment

(76) Inventor: Michael R. Lessard, Nottingham, NH (US)

Correspondence Address: BROWN, RAYSMAN, MILLSTEIN, FELDER & STEINER LLP, 900 THIRD AVENUE, NEW YORK, NY, 10022, US

(21) Appl. No.: 09/877,609

(22) Filed: Jun. 8, 2001

(51) Int. Cl. G06F 15/16

(52) U.S. Cl. 709/227

(57) ABSTRACT

The present invention discloses methods by which client computers working in a host operating environment can use from external data sources, which methods do not require nonvolatile storage of the data as native data to the host operating environment. The methods and operate transparently to a user of a client computer using the data through the host operating environment, and allow the data to be used as a first class participant in the host operating environment. Changes to the data can be saved nonvolitilely in the external data sources.

### CROSS-REFERENCE TO RELATED APPLICATION

This application is related to the U.S. application, Attorney Docket No. 3330/60, filed Jun. 8, 2001, and entitled, “VIRTUALIZING EXTERNAL DATA AS NATIVE DATA”, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to networked computer systems, and in particular to methods and systems for allowing use of data within a host operating environment in a networked computer system.

A modern business enterprise typically utilizes a networked computer system, in which users of individual client computers have access through a network to a server computer or server computers which provide the users with an operating environment, or host operating environment, through which the users can utilize one or more applications. The term “host operating environment” is here used broadly to include the computing environment provided by a server computer or server computers to one or more client computers, allowing one or more client computers access to and interface with various software, telecommunications methods, etc. provided by the server computer or server computers. The term “applications” is here used broadly to include various software programs that carry out some useful task, including tools and utilities. Frequently, a wide array of applications may be made available to provide an enterprise wide solution, including database applications, communications packages, graphics applications management tools, security-related applications, word processing applications, spreadsheet applications, intranet and/or Internet applications, various messaging applications, etc. In some instances, the applications may be integrated as part of an integrated application suite.

Data is of course frequently utilized by being accessed and manipulated by client computers through the use of the applications of the host operating environment. Access and manipulation activities include such actions as data searches, interrogation, replication, archiving, presentations, find and replace functions, mathematical operations, etc. Nonvolatile data storage is typically provided such that the data can be accessed and utilized by the applications of the host operating environment, e.g., integrated with the host environment, without the need to use emulator software or other programs, such as linking programs or utilities, to provide a translation or link between the host operating system and the data source. Data accessible by a host operating system in the foregoing way is herein termed “native” to the host operating system.

A problem often arises, however, when it is desired to access data from one or more non-native sources, e.g., external sources, having external data. External data is generally integrated for use in the application or applications that were designed to utilize the data, but not integrated for use in applications other than those applications, e.g., foreign applications. A group of data sources, each of which is not integrated for use in one or more applications for which at least one of the other data sources is integrated for use with, are referred to herein as a heterogeneous group. Frequently, it is desired for a client computer to access and manipulate external data, either separately from or together with native data. For example, a user of a client computer may wish to perform a search of a data set that includes a native data set and an external data set. Furthermore, a user of a client computer may wish to perform a search of a data set that includes data from several of a heterogeneous group of data sources, or to perform a search of a data set that includes native data and data from several of a heterogeneous group of data sources. Since the external data is not integrated for use with the host operating system, a difficulty arises. This difficulty may be exacerbated by the fact that the user of the client computer may be comfortable in, and skilled in using, the host operating environment and applications provided therein, and may be greatly inconvenienced if required to work outside of that environment. In addition, particular applications provided within the host operating environment may provide particular utility that is not available or not easily available outside the host operating environment.

Various approaches have been taken to dealing with this type of problem or similar types of problems as they arise in various different computing contexts. One approach, as described in U.S. Pat. No. 6,078,924, has been to create a single information platform that is intended to allow integration of data from a wide variety of formats. This approach, however, requires, among other things, the use of the described information platform, rather than enabling the use of a particular desired platform.

Various other approaches utilize programs, which may be known as emulator or linking programs, that are intended to provide a link between the host operating environment and an external data source. In providing the link, however, these approaches generally introduce a linking data scheme or system into the host operating environment that is foreign to the external data source and that was foreign to the host operating system prior to the inclusion of the linking program, and through which system external data is typically nonvolatilely stored as native data to the host operating environment, in addition to being stored nonvolatilely in the external data source.

The introduction of a data storage “middleman”, as just described, can cause complications of many sorts. For example, if data that is intended to have a single value and/or identity is nonvolatilely stored in more than one location, and changes to or deletions of the data are made, the possibility arises that the data may be changed in one location without being accordingly changed, or synchronized, in the other location, or without being synchronized sufficiently quickly. This can result in a host of problems, including errors or exceptions in the host operating environment, the need to incorporate cumbersome data checking and exception handling procedures into the host operating environment, loss of data, loss of data integrity, etc. For instance, problems can arise when several client computers attempt to access and manipulate the same data, and the likelihood of such problems tends to become greater as the client actions are closer together in time. To be more specific, one problem that can arise is that changes to data made by a first client computer may not be synchronized before a second client computer accesses the “same” data, which can result in errors or loss of data integrity.

In addition to the foregoing problems, many linking programs do not enable external data to be fully utilized and manipulable by applications within the host operating environment to the same extent as data that is native to the host operating environment. The external data thereby does not function as a “first class participant” in the host operating environment. Still further, in this and other ways, linking programs often operate such that, in one way or another, the user is reminded of and often inconvenienced by the operation of the linking program within the host operating environment. In this sense, the operation of linking program is not “transparent” to a user of the client computer who is accessing and manipulating external data.

There is a need in the art for methods by which client computers working in a host operating environment can access and manipulate data from one or more external data sources, which methods do not require nonvolatile storage of the data as native data to the host operating environment.

### SUMMARY OF THE INVENTION

It is an object of the invention to provide methods for allowing use of external data through a host operating environment as a first class participant in the host operating environment, which methods do not require nonvolatile storage of the external data as native data to the host operating environment.

It is another object of the invention to provide methods for virtualizing external data as virtual native data, the virtual native data being native to a host operating environment, to allow use of external data through the host operating environment.

In one embodiment, the invention provides, in a computer network having a server computer and a client computer connectable through the network to the server computer, in which an operating environment is available to the client computer, a method for integrating a set of data into the operating environment, wherein the set of data is from at least one source that is external to the operating environment. The method includes providing a connection between the network and the at least one source through which the set of data is retrieved through a host operating environment; adapting the set of data for use through the host operating environment; and, the client computer using the adapted data through the host operating environment, wherein the adapting and the using do not require nonvolatile storage of the set of data as native data to the host operating environment.

In another embodiment, the invention provides a method for virtualizing external data as virtual native data, the external data being from a source that is external to a host operating environment, and the virtual native data being native to the host operating environment. The method includes determining an external data set to be virtualized as a plurality of virtual native documents, the plurality of virtual native documents being native to the host operating environment; determining mapping data to associate each of a first set of data groups from the external data set with fields of the plurality of virtual native documents; utilizing the mapping data, determining wrapping data associated with each of a second set of data groups from the external data set, the wrapping data being for specifying characteristics of external data from the external data set as the fields of the plurality of virtual native documents; and, utilizing the wrapping data, allowing use of the external data through the host operating environment.

In another embodiment, the invention provides a method for virtualizing external data as virtual native data, the external data being from a source that is external to a host operating environment, and the virtual native data being native to the host operating environment. The method includes determining an external data table having a plurality of rows to be virtualized as a plurality of virtual native documents, the plurality of virtual native documents being native to the host operating environment; determining mapping data to associate columns from the external data table with fields of the plurality of virtual native documents; utilizing the mapping data, determining wrapping data associated with each of a plurality of rows from the external data table, the wrapping data being for specifying characteristics of each row of external data from the external data table as a virtual native document of the plurality of virtual native documents; and utilizing the wrapping data, allowing use of the external data through the host operating environment.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a distributed computer system incorporating a data virtualization program, according to one embodiment of the invention;

FIG. 2 is a block diagram of one embodiment of a distributed computer system in accordance with the system depicted in FIG. 1;

FIG. 3 is a block diagram showing operation of a data virtualization program, according to one embodiment of the invention;

FIG. 4 is a flow chart showing a method for integrating external data into a host operating environment, according to one embodiment of the invention;

FIG. 5 is a flow chart showing a method of operation of a data virtualization program, according to the method of FIG. 4;

FIG. 6 depicts an external database having a data table, which data table includes wrapping data, according to one embodiment of the invention;

FIG. 7 depicts an external database having a data table without wrapping data and a data table with wrapping data, according to one embodiment of the invention;

FIG. 8 is a flow chart showing a method for virtualizing data, according to one embodiment of the invention; and

FIG. 9 is a flow chart showing a method for utilizing wrapping data for data virtualization, according to one embodiment of the invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In one embodiment, the present invention generally provides methods by which client computers working in a host operating environment can access and manipulate data from one or more external data sources, which methods do not require nonvolatile storage of the data as native data to the host operating environment. In another embodiment, the invention generally provides a method for virtualizing an external data set as a plurality of virtual native documents, and allowing use of external data from the external data set through the host operating environment.

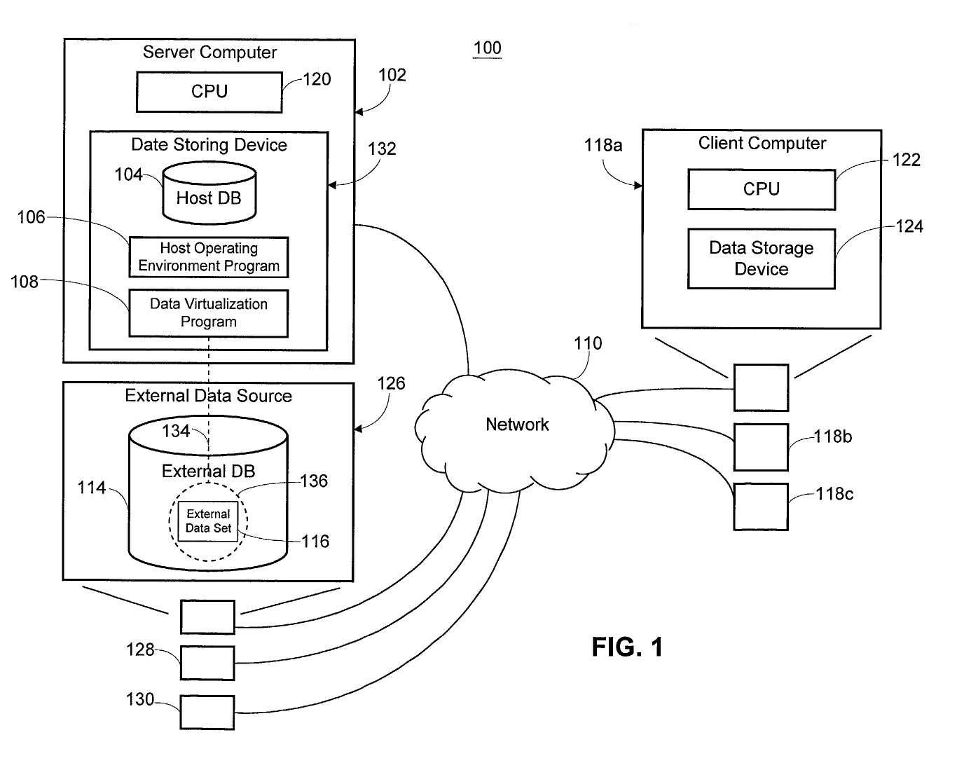

FIG. 1 is a block diagram of a distributed computer system 100 incorporating a data virtualization program 108, according to one embodiment of the invention. In the computer system 100 depicted in FIG. 1, a server computer 102 is connected to one or more external data sources 126, 128, 130 (three are shown), such as heterogeneous external data sources, and one or more client computers 118a-c (three are shown) via a network 110. The external data source 126 can be, for instance, a data store existing within a data storage device within a relational database management system. Although one server computer 102 is shown, the invention also contemplates multiple server computers. The network 110 depicted can broadly include an array of networks, which can include one or more local area networks, one or more wide area networks, and may also include a connection to the Internet, although embodiments of the invention are contemplated in which no connection to the Internet is provided.

Each client computer 118a-c comprises one or more Central Processing Units (CPUs) 122, and one or more data storage devices 124 which may include one or more Internet Browser programs.

The server computer 102 comprises one or more CPUs 120 and one or more data storage devices 132. The data storage device 132 comprises a host operating environment program 106, one or more host databases 104, which is a database that is native to the host operating environment provided by the host operating environment program 106 and contains native data, and a data virtualization program 108. The external data source 126 comprises one or more external databases 114 comprising one or more external data sets 116.

The data storage device 132 of the server computer 102 and the data storage devices of the client computers 118a-c, as well as the external data sources 126, 128, 130, may comprise various amounts of RAM for storing computer programs and other data. In addition, both the server computer 102 and the client computers 118a-c may include other components typically found in computers, including one or more output devices such as monitors, other fixed or removable data storage devices such as hard disks, floppy disk drives and CD-ROM drives, and one or more input devices, such as mouse pointing devices and keyboards.

Generally, both the server computer 102 and the client computers 118a-c operate under and execute computer programs under the control of an operating system, such as Windows, Macintosh, UNIX, etc. In the embodiment shown, the invention is implemented using the data virtualization program 108 executed from the server computer 102, although in alternative embodiments the data virtualization program 108 could be located and executed from one of the client computer 118a-c, or elsewhere. In addition, while in the embodiment shown the host operating environment program 106 is executed from the server computer 102, the invention also contemplates embodiments in which the host operating environment program 106 is located and executed elsewhere. The “host operating environment program” 106 is intended to be broadly interpreted as a composite, and may include and provide numerous applications that are part of a host operating environment extended to the client computers 118a-c.

The data virtualization program 108 is intended to broadly represent programming within or affecting the host operating environment to implement the methods of the invention within the distributed computer system 100 as described herein, and may include manipulation of the host operating environment or applications therein, such as by utilizing application programming interface (API) tools or other tools, as well as programs entirely introduced into the host operating environment. Furthermore, the data virtualization program can include programming for establishing and maintaining connection between a host operating environment and an external data source or sources. In some embodiments of the invention, the data virtualization program 108 includes programming to allow interface with and input from a system administrator or other user or manager of a host operating environment.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

The invention contemplates utility at least in situations in which one or more of the client computers 118a-c, connected to the network 110, request or attempt, through the host operating environment of the server computer 102, to utilize a data set 116 from the external data source 126, or several data sets from one or more of the external data sources 126, 128, 130. In such situations, the data virtualization program 108 is utilized to allow integration of external data as first class participant data into the host operating environment for access and manipulation by one or more of the client computers 118a-c through an application or applications provided by the host operating environment program 106. The data virtualization program 108 is capable of allowing integrating of external data so that it can be accessed and manipulated either together or without native data, and transparently to a user of a client computer 118a-c.

The data virtualization program 108 does not require the importation or copying of data from the external data source 126 to be saved nonvolatilely as native data to the host operating environment; rather, the data virtualization program 108 allows access and manipulation of external data within the host operating environment without requiring the external data to exist as nonvolatilely stored native data. External data only exists as native data volitilely, or transiently, in the context of the access and manipulation within the host operating environment. Changes to external data are saved by updating the external data in the external data source 126.

The data virtualization program 108 provides the programming to enable an external data set 116 to be “virtualized” as native data to the host operating environment for access and manipulation as a first class participant in an application or applications of the host operating environment, causing the external data set 116 to be fully utilizable by the application. Broken line 134 conceptually represents the function of the data virtualization program 108 in “virtualizing” the external data set 116. Conceptually, the data virtualization program 108 can be viewed as causing “wrapping”, as represented by broken circle 136, of the external data set 116 with any necessary attributes, associations, or qualities to allow it to be accessed and manipulated from within the host operating environment. By virtualizing the external data set 116, the data virtualization program 108 allows the external data set 116 to become a first class participant in the applications of the host operating environment, without the need for a nonvolatile data storage scheme to act as a link between the host operating environment and the external data source 126, and without the problems and disadvantages caused by such a scheme.

Since the data virtualization program 108 permits the flow of data between the external data sources 126, 128, 130 and the host operating environment (external data being stored only transiently in the host operating environment), data can also be effectively copied, or changed, edited, added to, or subtracted from, and then copied, from one of the external data sources 126, 128, 130 to one or more other of the external data sources 126, 128, 130, without the data virtualization program 108 at any point requiring storage of external data nonvolatilely as native data to the host operating environment.

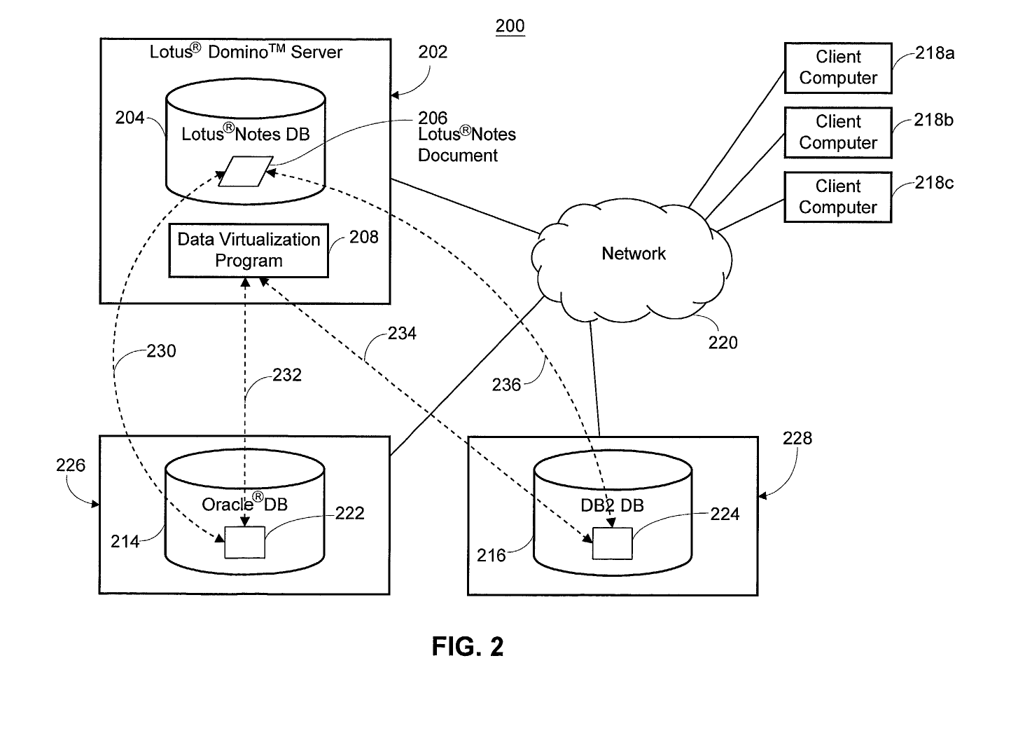

FIG. 2 is a block diagram of one embodiment of a distributed computer system 200 in accordance with the system 100 depicted in FIG. 1. As shown, a Lotus® Domino™ server 202, commercially available from International Business Machines (IBM®) Corporation, is connected via network 220 to an external data source 226 comprising an Oracle® database 214, commercially available from Oracle® Corporation, to an external data source 228 comprising a DB2 database 216, commercially available from IBM® Corporation, and to client computers 218a-c. Other examples of an external data sources that can be used with the present invention include Sybase® databases, available from Sybase® Corporation, Microsoft® Structured Query Language (SQL) servers, and any Open DataBase Compliant (ODBC) data source.

The Lotus® Domino™ server 202 comprises a Lotus® Notes database 204 comprising a Lotus® Notes document 206, and a data virtualization program 208. External databases 226 and 228 comprise external data sets 222 and 224, respectively. The Lotus® Notes document 206 is intended to generically represent any of various forms of data vehicles provided by applications running in the operating environment provided by the Lotus® Domino™ server 202, including various forms, views, and documents, and the term “documents” as used herein is intended to generically represent any of various data vehicles, including, for example, forms, views, and various other document types.

In one embodiment of the invention, a method performed by the system in FIG. 2 begins after one of the client computers 218a-c, via an application provided by the host operating environment, has requested performance of an operation requiring creation of or access to the Lotus® Notes document 206, and the requested operation requires access and manipulation of a data set comprising external data sets 222 and 224 from external data sources 226 and 228, respectively. As conceptually represented by broken arrows 230 and 236, the data virtualization program 208 causes the external data sets 222 and 224 to be associated with all of the attributes of the Lotus® Notes document 206, which may include form information or metadata information, revision history information, document data used by Lotus® Notes or applications running in the host operating environment in identifying the Lotus® Notes document 206, and potentially other information. This, in turn, enables the external data sets 222, 224 to be accessed and manipulated by host operating environment applications as native data. Since the data virtualization program 208 operates to virtualize the external data 222, 224 at the document level, as data associated with or having all the characteristics of a document that is native to the host operating environment, rather than operating at a lower data organizational level, such as the data field level, any linking program data schemes requiring nonvolatile storage of the external data 222, 224 as native data can be avoided while yet enabling first class participation of the external data 222, 224 in the applications of the host operating environment.

Since the external data 222, 224 becomes conceptually “wrapped” with all of the attributes of native data, such as data contained within a native document, the applications of the host operating environment can operate on the external data 222, 224 just as native data that is stored nonvolatilely can be utilized. Conceptually, the host operating environment “sees” the external data 222, 224 as native data for purposes of the access and manipulation operation, and the host operating environment and applications provided thereby can operate on the virtualized native data identically to native data. Additionally, the fact that the external data 222, 224 is external data can be transparent to a user of the one of the client computers 218a-c initiating the request communicated to the Lotus® Domino™ server 202 and causing the data access and manipulation. Furthermore, the external data 222, 228, being manipulable through the host operating environment, can be copied or replicated from one of the external sources 226, 228 to the other of the external sources 226, 228, or to one or more other external sources entirely, utilizing the applications of the host operating environment.

In the embodiment depicted in FIG. 2, programming accomplished via the Lotus® Domino™/Notes API and the Lotus® Connector API are utilized in establishing the programming “framework” for connection between the host operating environment and the client computers 218a-c.

The present invention provides many advantages by operating at the document level and yet not requiring nonvolatile storage of external data as native data to a host operating environment. Documents can be conceptually thought of as “containers” for data, with sets of data assigned to fields of the document. Documents may specify fields within the document, the layout of those fields, and various other attributes of the document itself. Documents are thus a hierarchically higher organizational level of data storage than fields. Since a host operating environment “recognizes” native documents, data associated with a native document and with a field of the native document has characteristics or attributes within the host operating environment as a result of those associations, and in this sense the data can be thought of as being “wrapped” with information relating to the associations.

For instance, one kind of document is a form. A simple form could specify the fields that it contains as well as the layout of the fields in the form. Thus, the layout of the fields in the form is an attribute of the form, which may enable it, and the data it contains in its fields, to be used through the host operating environment. Of course, in complex databases and database systems, such as the Lotus® Notes database and others, documents can be much more sophisticated than the simple form just described, and can include hundreds of attributes, which attributes are recognized by the host operating environment to which the document is native. Other attributes of documents can relate, as one of many examples, to security features restricting access to the data contained within the document. The attributes of a document enable the document, and the data contained therein, to be utilized and manipulated in various ways in the host operating environment. Furthermore, as mentioned above complex database systems can include a variety of types of documents, the type of document being characterized by the attributes associated with the document. By virtualizing external data at the document level, the present invention allows a full range of manipulation of the external data, as if the external data were stored nonvolatilely as a document in the host operating environment. In certain embodiments of the invention, external data can be virtualized as a particular type of virtual native document. In different embodiments, the type of document to serve as a virtual native document may be selected by the data virtualization program 208, by a system administrator or other user of one or more of the external data sources 226, 228, or in other ways.

Some systems for allowing use of external data operate at the field level by causing external data to be copied into fields of native documents, sometimes called stub documents, which nonvolatilely stored native documents serve as a vehicle of the host operating environment for allowing use of the data within the host operating environment. Since the external data is copied or imported from the external data source and stored nonvolatilely for use in the host operating environment, changes to the copied external data through the host operating environment must be synchronized with the external data in the external database, to cause the external data stored in the external database to be updating accordingly. The present invention, by contrast, allows use of external data without requiring copying of the data into the host operating environment, so that synchronization is unnecessary. The present invention allows external data to be virtualized at the document level of organization rather than, for example, causing the external data to be copied to and nonvolatilely stored in a host operating environment document.

While the methods of the present invention do not themselves require nonvolatile storage of external data as native data, it should be kept in mind that some host operating environments operate such that external data utilized within the host operating environment is stored nonvolatilely within the host operating system, sometimes for very short periods of time, such as, for example, through file swapping operations. The present invention can be utilized in and maintains its advantages in such host operating environments, and any nonvolatile storage of external data as native data is an incidental to the host operating environment operation and not necessitated by the methods of the invention themselves.

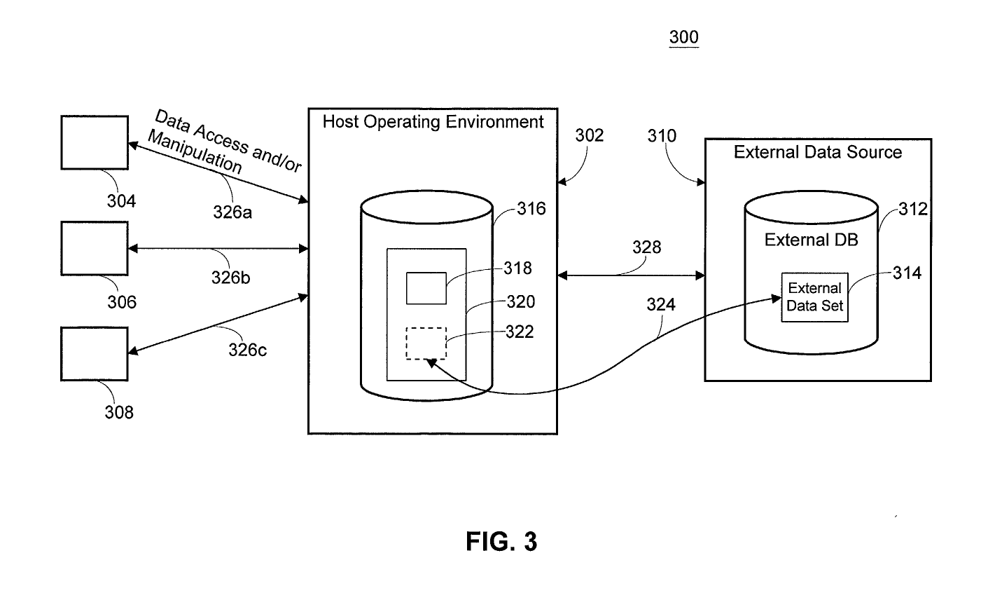

FIG. 3 is a block diagram showing operation of a data virtualization program according to one embodiment of the invention. As shown in FIG. 3, within a conceptually represented host operating environment 302, a native database 316 is shown. The host operating environment 302 is usable by client computers 304, 306, 308 and allows communication with the external data source 310. Native database 316 comprises native data set 320, which can be a native document, form, view or other native data-containing vehicle. External data source 310 comprises external database 312, which comprises external data set 314.

As represented by arrows 326a-c, the client computers 304, 306, 308 can access and manipulate data utilizing the host operating environment 302, and, as represented by arrow 328, two-way communication between the external data source 310 and the host operating environment 302 is provided. As shown, the data set 320 comprises native data set 318, which may be nonvolatilely and/or volatilely stored as native data within the host operating environment 302, and virtualized external data set 322, the virtualized external data set 322 being transiently stored in the host operating environment 302 and being the result of virtualization of external data set 314 by a data virtualization program (not shown). In some embodiments of the invention, data set 320, comprising a combination of the native data 318 and the virtualized external native data set 322, exists during performance of a data access and manipulation action requested by one of the client computers 304, 306, 308 through the host operating environment 302. Although the native data set 318 and the virtualized external data set 322 are represented separately, they may intermingle and be used in an integrated fashion as the data set 320 by applications within the host operating environment 302.

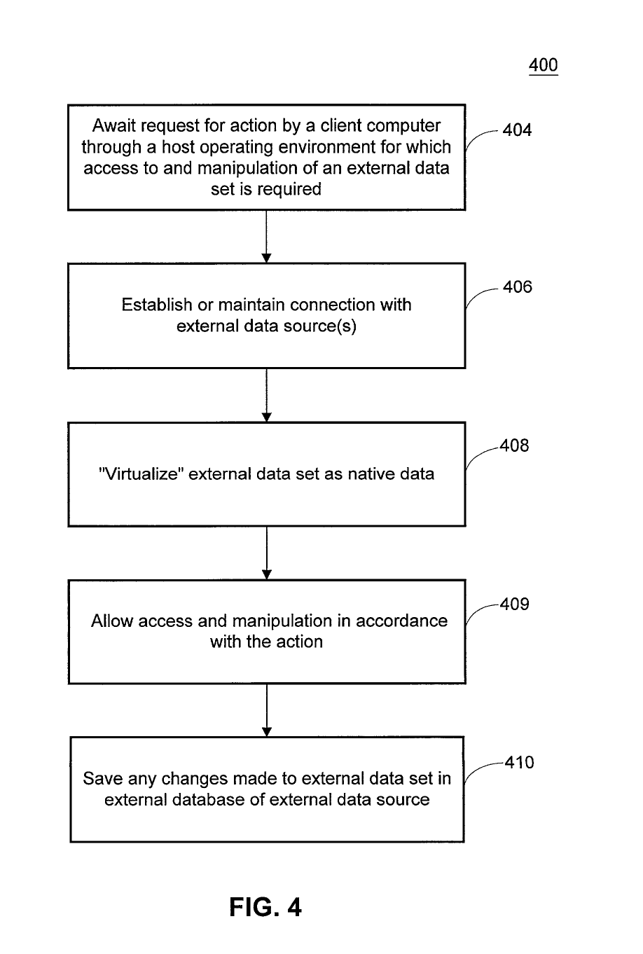

FIG. 4 is a flow chart showing the method 400 of operation of one embodiment of the invention, implemented through the use of a data virtualization program operating within a computer system. The method depicted in FIG. 4 allows access and manipulation through a host operating environment of external data that has been virtualized as native data, referred to as virtualized external data. First, at step 404, the method awaits a request for action by a client computer through a host operating environment, for which access to and manipulation of an external data set is appropriate or required. Step 404 could be, for example, the result of a data search requested by a user of a client computer and communicated to a server computer providing the host operating environment. At step 406, the method 400 establishes a communicative connection with the external data source containing the external data to be accessed and manipulated, or, if a connection exists already, maintains the existing connection. At step 408, the method 400, via operation of the data virtualization program, virtualizes the external data set needed for the requested action. At step 409, the method 400 allows access and manipulation of the virtualized external data set accordingly, via the host operating environment. Note that the action may simultaneously and seamlessly utilize native data as well as the external data that has been virtualized. At step 410, any changes, including edits, additions, and/or deletions, made to the virtualized external data, via the action taken utilizing the operating environment, are saved in an external database of an external data source from which the external data set came. The method 400 represents use of a data virtualization program of one embodiment of the invention to allow access and manipulation of external data through a host operating environment.

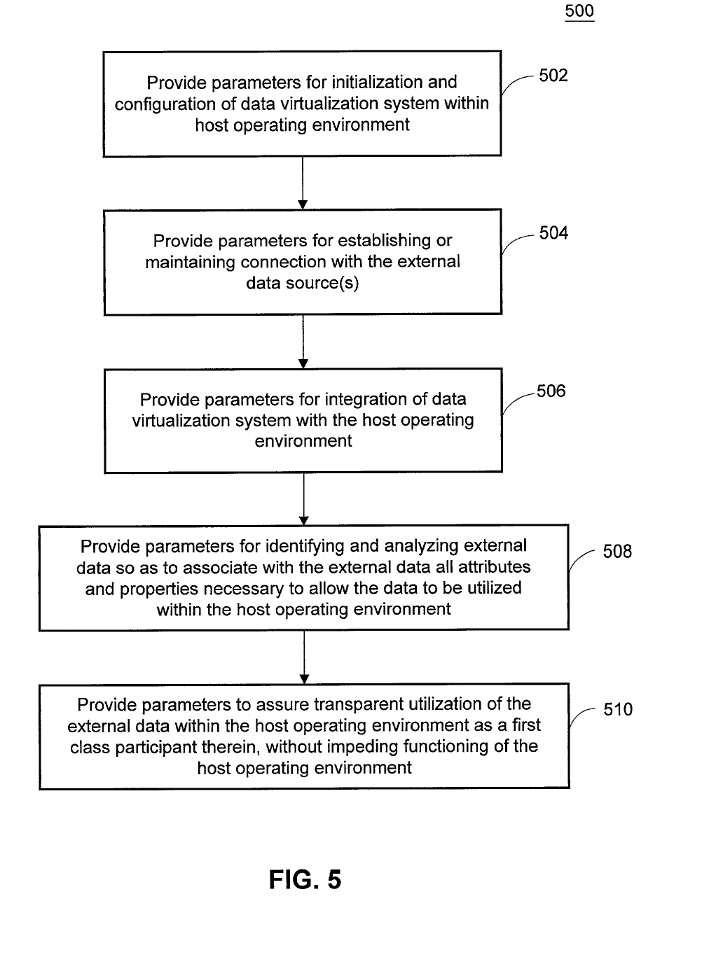

FIG. 5 is a flow chart showing one embodiment of a method 500 of operation of virtualization of data as host data for access and manipulation through a host operating environment. In various embodiments of the invention, various activities included in the steps of method 500 may be performed automatically by the data virtualization program or by a system administrator, network manager or other user of a host operating environment utilizing, for example, applications provided by the data virtualization program and running in the host operating environment.

At step 502, a data virtualization program according to one embodiment of the invention provides parameters for initialization and configuration of a data virtualization system according to one embodiment of the invention within a host operating environment, effectuated by a data virtualization program. In one embodiment of the invention, this includes providing an application enabling a system administrator, network manager, or other user, through an interface provided by the application, to specify the parameters and to specify settings relating to scheduling of data virtualization activity, such as whether such activity should occur on an automatically scheduled basis or a manually selected basis. In one embodiment of the invention, the application is a native application, likely familiar to the user, that provides one or more easy to use point and click forms for selecting configuration option settings. Other aspects of initialization and configuration may be accomplished via an initialization file and a native API.

At step 504, the method 500 provides parameters for establishing or, if already established, maintaining connection with the one or more data sources, which can be at least partially accomplished by programming through the use of APIs. Step 504 can include identifying the type and location of an external data source (e.g., an Oracle® Version 8 database and a machine name or network address), and external data table name or owner information. Additionally, step 504 may include providing security related information, such as user name and password information. Additional security related information can include selecting whether security should be enforced by the host operating environment or by a system associated with the external data source, or both. For example, the user may select whether security should be enforced only by the host operating environment, or whether additional credentials beyond what is needed to use the host operating environment must be provided in order to access an external data source.

At step 506, the method 500 provides parameters for integration of a data virtualization system of the invention with the host operating environment. Typically, step 506 is accomplished through the use of host operating environment APIs. In some embodiments, this involves determining parameters for utilizing event handlers to intercept information relating to certain host operating environment operations being carried out, which operations may, for example, indicate a request by a client computer for an action which requires use of external data. The event handlers may then initiate appropriate data virtualization activity.

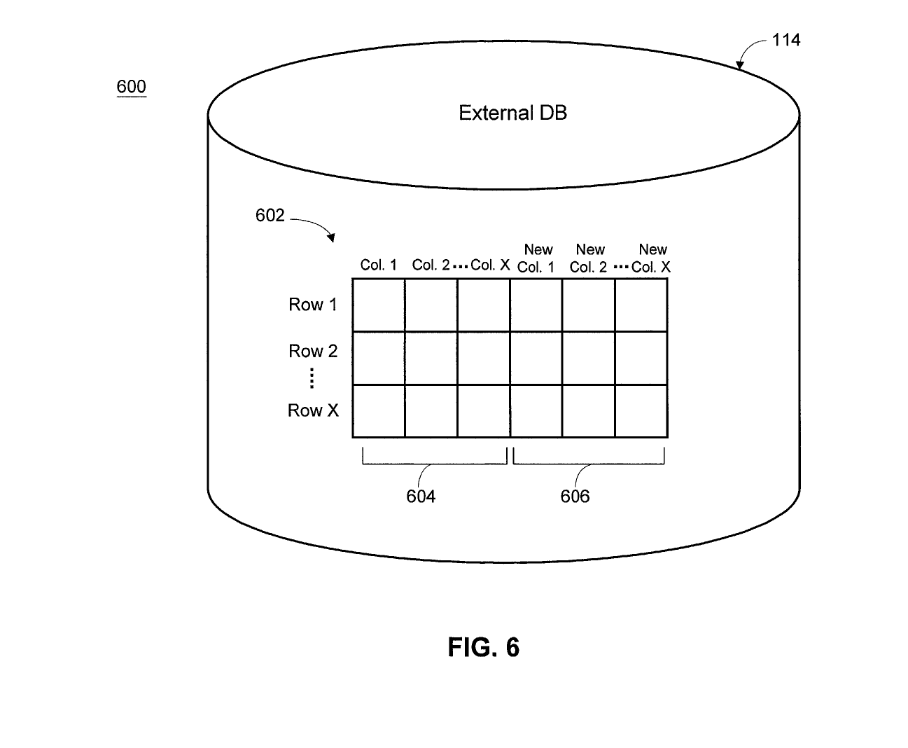

In some embodiments of the invention, steps 508 and 510 of the method 500 are accomplished in part through data mapping activity and storage of nonvolatile storage of wrapping data, as described with reference to FIGS. 6-9.

At step 508, the method 500 provides parameters for identifying and analyzing external data so as to associate with the external data all attributes and properties necessary to allow the data to be utilized within the host operating environment. Step 510 can include data mapping activity, as described with reference to FIGS. 6-9, and specification of how to resolve possible resulting data integrity or data precision issues.

At step 510, the method 500 provides parameters to assure transparent utilization of the external data within the host operating environment as a first class participant therein, without impeding functioning of the host operating environment. In some embodiments, step 510 includes determining and specifying characteristics or attributes that need to be associated with external data so that the data can be used in the host operating environment.

The details of the implementation of the method 500 depicted in FIG. 5, and in fact of many implementations of a data virtualization program or data virtualization system are highly dependent on the particular host operating environment and the particular external data source or sources. However, utilizing the teachings of the invention, one skilled in the art can implement the invention in a variety of settings utilizing common programming skills and procedures.

FIG. 6 depicts an external data source 600 including one embodiment of the external database 114 having an external data table 602 containing external data 604 as well as wrapping data 606. The external data table 602 comprises a plurality of rows 1-X, the rows 1-X being groups of associated data, and a plurality of columns, including columns 1-X of external data 604 and new columns 1-X of wrapping data 606, each column specifying metadata or data type information associated with data in the column. In the embodiment shown in FIG. 6, the external data set is the external data table 602, and comprises rows and columns; however, the invention also contemplates other types of external data sets and the use of data groups other than rows and columns.

New columns 1-X of wrapping data 606 are added to external data table 602, causing wrapping data to be appended to each row 1-X of external data. In the embodiment shown, the wrapping data 606 is stored nonvolatilely in the external data source 600 in order to specify or identify characteristics or attributes of the external data 604 so as to enable virtualization of the external data 604. One or more particular columns of wrapping data, such as new column 1, may be utilized to provide a unique identifier in the host operating environment for rows of external data.

In one embodiment of the invention, prior to the addition of the wrapping data 606, a system administrator, network manager or other user of the host operating environment specifies or maps columns 1-X of the external data table 602 with associated fields of a native document, so that the appropriate wrapping data 606 can be determined and stored as new columns 1-X by being appended to the rows 1-X of the external data table 602, providing the necessary information for the data virtualization program to allow the external data 604 to be virtualized and used as a first class participant through the host operating environment. In other embodiments of the invention, the mapping function may be performed automatically by a data virtualization program. Mapping results in the determination of mapping data, which can be stored as native data in the host operating environment or in other ways, and which mapping data is utilized by the data virtualization program to virtualize the external data table 602 as a plurality of virtual native documents.

For example, in the embodiment depicted in FIG. 6, each row 1-X of data is associated with a virtual document, specifically, a virtual form. As mentioned above, one of the new columns 1-X of wrapping data 606 can be used to provide a unique identifier record for identifying each particular row, and for identifying the virtual form associated with that row. The fields of each virtual form are populated with data from the associated row. The new columns 1-X supply the wrapping data 606. Various columns of wrapping data for each row can be used by the host operating environment to determine various attributes of the virtual form associated with each row. As just one example, one of the new columns 1-X can specify a security or restricted access characteristic associated with the virtual form associated with that row.

In one embodiment of the invention, the data virtualization program is used to provide wrapping data for a plurality of data tables, such as data table 602, within an external data source, such as the external data source 600, so that all of the external data from the plurality of data tables can be virtualized as a plurality of virtual documents and used through a host operating environment. If virtualized external data, such as the external data 606, is changed, added to, or deleted from through the host operating environment, appropriate updates, additions, or deletions of external data are performed to the external data 606. In addition, wrapping data, such as the wrapping data 606, is updated, added, or deleted, as appropriate.

In addition to initially providing wrapping data 606, a data virtualization program Can be configured to periodically monitor the external data table 602, to provide any necessary updates or additions to the wrapping data 606. For instance, if external data is added to the external data table 6023 through a system external to the host operating environment, such as through a system associated with the external data source 600, a data virtualization program can detect the addition and determine and store wrapping data as appropriate.

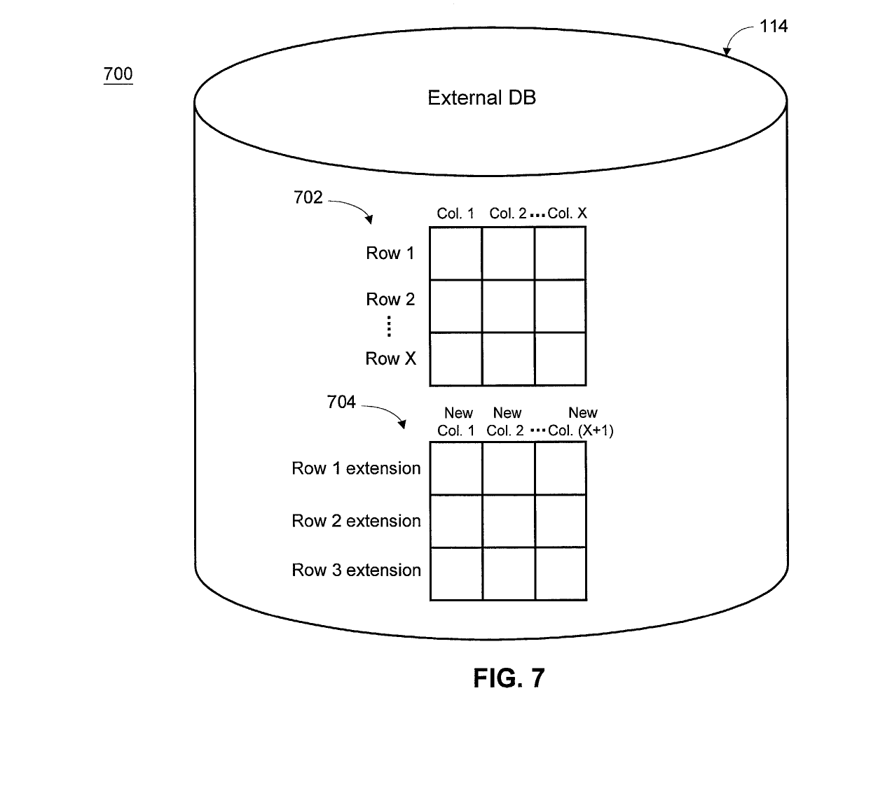

FIG. 7 depicts an alternative embodiment of the external database 114 to the embodiment depicted in FIG. 6. As depicted in FIG. 7, an external data source 700 includes external database 114, which comprises external data table 702, comprising rows 1-X and columns 1-X, and wrapping data table 704, comprising row extensions 1-X and new columns 15 (X+1). In the embodiment depicted in FIG. 7, wrapping data is provided in a separate table 704 from the external data table 702. Wrapping data table 704 requires an additional column of wrapping data as compared with an embodiment in which wrapping data is appended to an external data table, because one column of wrapping data in the wrapping data table must be used to associate the each of the row extensions 1-X of the wrapping data table 702 with each of the rows 1-X of the external data table 704, so that the row extensions 1-X can be used as if they were appended to the rows 1-X. In some situations, the embodiment depicted in FIG. 7 is preferable to the embodiment depicted in FIG. 6 because the embodiment depicted in FIG. 7 does not require any alteration of the external data table 702.

In the embodiments depicted in FIGS. 6 and 7, wrapping data is stored in an external database containing external data that may be virtualized, but in alternative embodiments, the wrapping data can be stored elsewhere and associated with groups of the external data by, for example, a data key.

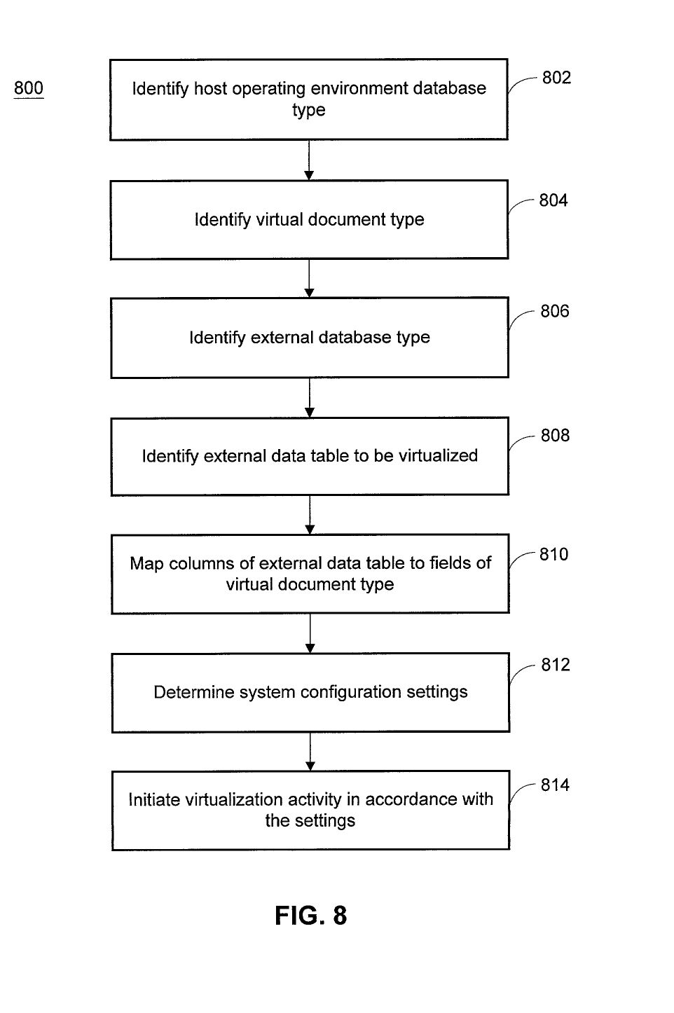

FIG. 8 is a flow chart showing a method 800 for virtualizing data, according to one embodiment of the invention. In various embodiments of the invention, steps of method 800 can be performed automatically by a data virtualization program, or with input from a host operating environment user such as a host operating environment system administrator utilizing a native application provided as part of a data virtualization program.

At step 802, the data virtualization program identifies the host operating environment database type. At step 804, the type of native document to be utilized as a data virtualization document is identified. At step 806, the type of external database is identified. At step 808, the particular type of external data table to be virtualized is identified. At step 810, columns from the external data table are mapped to fields of the type of virtual document as identified at step 804. At step 812, system configurations are determined. At step 814, data virtualization activity is initiated in accordance with the settings. Step 814 could include activating an aspect of the data virtualization program to determine and store wrapping data, monitor the host operating environment to intercept calls that require data virtualization, to monitor an external data tables for changes through an external system and to update wrapping data accordingly. Data virtualization activity also includes utilizing wrapping data to allow use of external data in the host operating environment and updating external data and wrapping data accordingly.

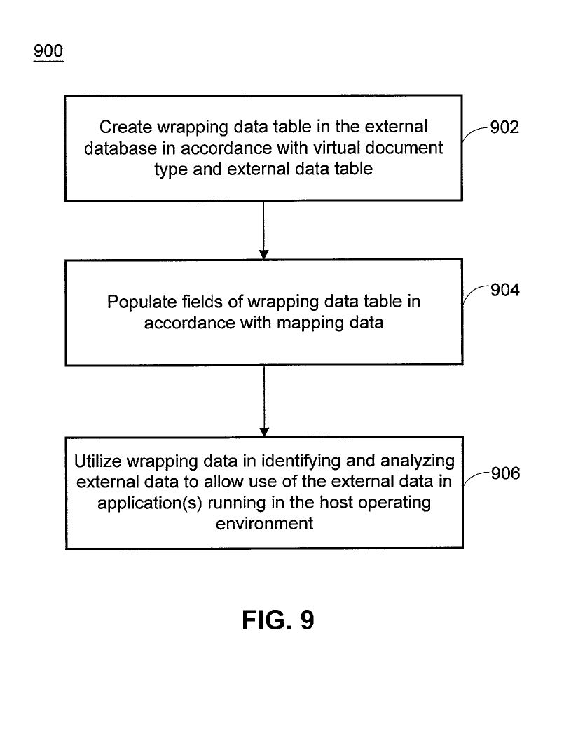

FIG. 9 is a flow chart showing a method 900 for utilizing wrapping data for data virtualization, according to one embodiment of the invention. At step 902, the data virtualization program creates a wrapping data table, such as wrapping data table 704 described with reference to FIG. 7. At step 904, the data virtualization program populates fields of the wrapping data table with wrapping data determined utilizing and in accordance with mapping data.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. In a computer network having a server computer and a client computer connectable through the network to the server computer, wherein an operating environment is available to the client computer, a method for integrating a set of data into the operating environment, wherein the set of data is from at least one source that is external to the operating environment, the method comprising:
providing a connection between the network and the at least one source through which the set of data is retrieved through a host operating environment;
adapting the set of data for use through the host operating environment; and the client computer using the adapted data through the host operating environment, wherein the adapting and the using do not require nonvolatile storage of the set of data as native data to the host operating environment.

2. The method of claim 1, wherein using the adapted data through the host operating environment comprises using the adapted data as a first class participant within the host operating environment.

3. The method of claim 2, comprising, if the set of data is changed through the use of the adapted data:
appropriately updating the set of data in the at least one source; and
appropriately updating a set of wrapping data associated with the set of data, if any updating of the wrapping data is appropriate.

4. The method of claim 1, wherein the set of data is transiently stored as data that is native to the operating environment, during the use thereof.

5. The method of claim 1, comprising use of the set of data by more than one client computer.

6. The method of claim 1, wherein the at least one source comprises a relational database system.

7. The method of claim 1, wherein the at least one source comprises an Open DataBase Compliant (ODBC) data source.

8. The method of claim 1, wherein adapting the set of data comprises:
determining wrapping data associated with the external data, the wrapping data being for specifying characteristics of the set of data as native data to the host operating environment; and
storing the wrapping data externally to the host operating environment.

9. The method of claim 8, comprising:
mapping groups of the external data to fields of a native document; and
using the mapping data in determining the wrapping data.

10. The method of claim 1, comprising:
providing parameters for initialization and configuration of a data virtualization system within the host operating environment;
maintaining connection with the at least one external data source;
providing parameters for integration of the data virtualization system with the host operating environment; and
providing parameters for identifying and analyzing the set of data so as to associate with the set of data attributes and properties necessary to allow the set of data to be utilized as a first class participant within the host operating environment and to assure maintenance of operation of the host operating environment unimpeded by the data virtualization system.

11. A computer usable medium storing program code which, when executed on a computerized device, causes the computerized device to execute a method, in a computer network having a server computer and a client computer connectable through the network to the server computer, wherein an operating environment is available to the client computer, the method being for integrating a set of data into the operating environment, wherein the set of data is from at least one source that is external to the operating environment, the method comprising:
providing a connection between the network and the at least one source through which the set of data is retrieved through a host operating environment;
adapting the set of data for use through the host operating environment; and
the client computer using the adapted data through the host operating environment, wherein the adapting and the using do not require nonvolatile storage of the set of data as native data to the host operating environment.
